(19) United States
(12) Patent Application Publication
(10) Pub. No.: US 2005/0072826 A1
(43) Pub. Date: Apr. 7, 2005

(54) Gift wrap roll storage and cutting box

(76) Inventors: Carla D. Sewell, Owings Mills, MD (US); Veronica Y. Dix, Catonsville, MD (US); Kimberly E. Coates, Baltimore, MD (US); Antoinette Laster, Randallstown, MD (US)

Correspondence Address: Richard C. Litman;LITMAN LAW OFFICES, LTD., P.O. Box 15035, Arlington, VA, 22215, US

(21) Appl. No.: 10/911,479

(22) Filed: Aug. 5, 2004

Related U.S. Application Data
(60) Provisional application No. 60/494,288, filed on Aug. 12, 2003.

(51) Int. Cl. B26F 3/02

(52) U.S. Cl. 225/49

(57) ABSTRACT

A gift wrap roll storage and cutting box is a rectangular open top container having a short front wall parallel to a tall rear wall and a lid that covers the open top of the container. The lid is pivotally attached to the tall rear wall of the container. When the lid is closed over the container; the lid slopes downward from the tall rear wall to the short front wall. The lid has a slit disposed near the rear of the lid through which a sheet of gift wrap paper is drawn and a serrated cutting edge disposed near the front of the lid to sever the sheet of gift wrap paper. The slit and the cutting edge are separated by a distance that provides the user with a place to rest their hand while pulling a sheet of gift wrap paper along the cutting edge.

### CROSS-REFERENCE TO RELATED APPLICATION

This application claims the benefit of U.S. Provisional Patent Application Ser. No. 60/494,288, filed Aug. 12, 2003 .

### BACKGROUND OF THE INVENTION

1. Field of the Invention

The present invention relates generally to dispensing boxes. More specifically, the invention is a mountable dispensing box for cutting sheets of wrapping paper from a roll.

2. Description of the Related Art

Most people wrap gifts prior to presenting them to the recipient. Gift wrapping is a delicate process. Precautions must be taken to protect the wrapping paper prior to and after the gift is wrapped. Storing wrapping paper is also a delicate matter, especially when excess paper is unrolled. The wrapping process is further complicated by wrapping paper being disposed on long, unwieldy tubes making it difficult to quickly wrap gift items. Also, when the roll of wrapping paper is stored away for future use, special precautions need to be taken to prevent the paper from being damaged. A device is needed that will store rolled wrapping paper in a convenient to use container that allows the user to dispense and cut a specific amount of paper when desired. It is further desired that the device be mountable on any surface, such as a wall or a table.

U.S. Patent Publication No. 2002/0125162, published on Sep. 12, 2002, describes a holder for wrap dispensers. The holder is box-like in shape and is sized to be larger than the size of the dispenser. The holder has a dispenser retainer attached within to maintain the dispenser within the holder. An ejector spring is also disposed within the holder to easily eject the dispenser from the holder to a graspable position when released. The holder can be attached to attachment members on a structure via a fastener element.

U.S. Pat. No. 2,189,533, issued to Harold C. Harvey on Feb. 6, 1940, describes a rectangular dispensing paper box or container for roll paper. The dispenser has a finger opening at the center front edge for controlling the dispensing of paper. Longitudinal paper holder portions hold the paper inside the dispenser and guide the paper from the bottom of the box up to the front top portion. The box is fabricated from a blank and is folded into the final box with end flaps. The box is not made from a single piece, but must have the internal paper holder portions. A serrated front edge is provided at the front edge. The dispenser box is distinguishable for requiring internal paper holder extensions, a finger opening, and being fabricated from a blank paper form.

U.S. Pat. No. 2,771,186, issued to Wendell T. Burbank on Nov. 20, 1956, describes a paper sheet dispensing carton having a cutter. The carton is rectangular is shape and has a hinged cover with a cutter on the carton. The cutter is formed from bendable ribbon stock having diverging flanges and is positioned over the edge of the front wall of the carton. The teeth of the cutter can have various forms and be separated. The carton is distinguishable for requiring cutting teeth of various shapes.

U.S. Pat. No. 2,888,180, issued to John C. Kinker, Jr. on May 26, 1959, describes a tear strip for dispensing sheet material from a dispensing package. The tear strip is made from a thin narrow strip of metal, such as aluminum, and is attached to a front wall of the package, adjacent the free edge of the front wall. The package has a top wall that covers the tear strip and therefore renders the strip harmless to a user, but still sufficient to cut a sheet portion from the roll. The tear strip is distinguishable for covering the aluminum tear strip under the top wall.

U.S. Pat. No. 2,888,181, issued to Henry A. Lincoln et al. on May 26, 1959, describes a dispensing container for sheet material comprising an abrasive strip of granular material along one of the longitudinal edges proximate, or 180° away from, the outlet edge and being between 1/64 and 1/2inch wide. The device is distinguishable for disposing the abrasive strip in various locations from the outlet edge.

U.S. Pat. No. 3,262,620, issued to Robert V. Burt et al. on Jul. 26, 1966, describes a combination display and dispensing package for a roll of continuous sheeting material. The package has two open longitudinal sides, allowing the user to plainly see the sheet material, and four tubular pyramidal supports within the package for retaining the sheet material. The cutting blade is positioned at the bottom front edge of the container. The device is distinguishable for possessing two open longitudinal sides and four retaining supports.

U.S. Pat. No. 3,281,036, issued to George V. Woodling on Oct. 25, 1966, describes a carton dispenser having an elongated blank paperboard dispensing edge. The carton has a lid with a flange panel, wherein the rear corners of the lid have tear starting features, such as notches, metal teeth, abrasive glue, and metal staples. The device is distinguishable for requiring tear starting patches at only the corners of the lid.

U.S. Pat. No. 4,005,809, issued to William W. Finn on Feb. 1, 1977, describes a dispenser carton wherein the bottom edge of a front panel possesses a strip of silicate containing adhesive for cutting a paper roll. The device is distinguishable for requiring the cutting silicate strip along the bottom edge of the front panel.

U.S. Pat. No. 4,130,228, issued to Ronald Perrin on Dec. 19, 1978, describes a film dispensing container having a cutting edge on the lower portion of the cover at the same place where the film is dispensed from the container. The cutting edge can be tucked into the box for shipping and safety. The device is distinguishable for requiring a tuck-in cutting edge.

U.S. Pat. No. 4,334,644, issued to Donald P. Hauser on Jun. 15, 1982, describes a dispenser carton having a full width front flap with an abrasive inside edge to prevent inadvertent withdrawal of additional sheet material. The device is distinguishable for requiring the abrasive on an inside surface of the full front side lid.

U.S. Pat. No. 4,340,162, issued to Joseph L. Heiman et al. on Jul. 20, 1982, describes a roll dispenser carton having a cutting edge disposed on a corner of a top panel on the carton. The cutting edge comprises a series of buds, each having at least two petals. The cutting edge permits sheet material to be cut while also retaining the free edge once the sheet is cut. The device is distinguishable for requiring a cutting edge of a series of buds.

U.S. Pat. 4,346,830, issued to Donald P. Hauser on Aug. 31, 1982, describes a dispenser carton having a cutting edge along the bottom front wall comprising a series of serrated sections alternating with a series of folded sections that are roll-coated with aluminum oxide, sand or silicon carbide particles in an adhesive. The device is distinguishable for requiring an abrasive strip on the edge of the bottom front panel.

U.S. Pat. No. 4,465,215, issued to Hisao Kai on Aug. 14, 1984, describes a cutting edge device for a paper sheet dispensing container. The cutting edge is disposed on the corners of the container and comprises finely divided grindstone particles applied by an adhesive to the front bottom corners of the container. The device is distinguishable for requiring only the deposition of the cutting regions on the front bottom corners of the container box.

U.S. Pat. No. 4,474,318, issued to Ronald Perrin on Oct. 2, 1984, describes a dispensing carton having a cutting edge that uses a clamp system to hold sheet material as it is cut on the cutting edge. The cutting edge is made of a metal or plastic saw-toothed strip on the edge between the front wall and the bottom of the container. The device is distinguishable for requiring the cutting edge to be on the junction between the front wall and the bottom.

U.S. Pat. No. 5,425,486, issued to George K. Kurker on Jun. 20, 1995, describes a wrap dispenser device with a compressible support using a half-inch thick layer of sponge-like material joined in an orthogonal and longitudinal relationship under and behind, respectively, the roll of sheet material. The device is distinguishable for requiring a spongy support material inside the box.

U.S. Pat. No. 5,732,868, issued to Cole W. Gammon, Jr. on Mar. 31, 1998, describes a cubical cardboard container in the second embodiment having a slot adjacent the safe cutting element at the front corner edge, and an intermediate protruding plastic strip for adhering to the cut sheet. The cutting element comprises particles of sand and various silicates adhered by any adhesive. The device is distinguishable for requiring a protruding plastic strip between the opening for the sheet and the cutting element on the front panel.

British Patent No. 1,124,769, published on Aug. 21, 1968, describes a household wrap dispenser and cutter device. The dispenser comprises an outer metal-hinged cover, which extends over an opening and a scalloped blade. The dispenser device is distinguishable for requiring a metal-hinged cover containing a scalloped blade.

British Patent No. 1,427,662, published on Mar. 10, 1976, describes a dispenser for sheet material. The dispenser is a wall mountable, cylindrical housing having a hinged cover that must be opened to expose a rear opening for dispensing the sheet and a frontal cutting teeth row.

International Patent No. WO 92/16445, published on Oct. 1, 1992, describes a plastic film sheet dispenser comprising a mountable housing having a cover unit and a releasable base unit held in place with resiliently biased locking tabs. The film is dispensed through a slot on the bottom rear of the housing, and severed by a cutter element having V-shaped teeth located at the bottom front of the housing. A discontinuous rough bottom surface on the dispenser discourages the clinging of the sheet. The dispenser is distinguishable for requiring a rough bottom surface.

Other dispensers are disclosed in: U.S. Pat. No. 5,941,476, issued to Nicholas S. Copass on Aug. 24, 1999; U.S. Pat. No. 5,630,563, issued to Edward H. Meisner et al. on May 20, 1997; U.S. Pat. No. 5,620,128, issued to Robert K. Dingman on Apr. 15, 1997; U.S. Pat. No. 5,301,854, issued to Brad Scobey on Apr. 12, 1994; U.S. Pat. No. 5,292,046, issued to Kaiser on Mar. 8, 1994; U.S. Pat. No. 5,222,644, issued to Ruth B. Moreno on Jun. 29, 1993; U.S. Pat. No. 5,186,376, issued to Scharf et al. on Feb. 16, 1993; and U.S. Pat. No. 4,934,575, issued to Mustafa on Jun. 19, 1990 .

None of the above inventions and patents, taken either singly or in combination, is seen to describe the instant invention as claimed. Thus, a gift wrap roll storage and cutting box solving the aforementioned problems is desired.

### SUMMARY OF THE INVENTION

The gift wrap roll storage and cutting box is a rectangular container having a short front wall, a tall rear wall, a bottom wall, and two end walls that define an open-top cavity. The cavity receives and stores a roll of gift wrap paper and is covered by a rectangular shaped lid having a front edge, a rear edge and two side edges. The rear edge of the lid is attached to the box's tall rear wall. The lid lies in an inclined slope when it is in a closed position. The lid is kept closed by fasteners, such as tabs or snap clasp closures.

The lid has a horizontal slit disposed adjacent and parallel to the rear wall of the box and a serrated cutting edge that is parallel to the horizontal slit and disposed at the front edge of the lid. In use, a user draws up a sheet of gift wrap paper from the gift wrap paper roll through the slit, draws the paper across the top of the lid and severs the desired length of paper along the serrated edge disposed at the front of the box.

The box can be easily used in the user's hand or upon a surface. Knock out keyholes are disposed on the rear wall and the bottom wall of the rectangular container to mount the box on any surface. The knock out holes disposed on the rear wall allow the box to be mounted on a vertical surface using nails or suction cups. The knock out holes disposed in the bottom wall of the box permit the box to be mounted on a horizontal surface, preferably by using suction cups.

The box may be made of cardboard, metal or plastic, and can be either transparent or translucent when made from plastic. The box can be any length. Ideally the box is 18″ long and retains an 18″ roll of gift wrap paper that is conveniently held in one hand. The box however can be made to be 30″ long to hold a single 30″ roll of gift wrap paper or be 32″ long to hold a single 32″ roll of gift wrap paper.

Accordingly, it is a principal object of the invention to provide a gift wrap roll storage and cutting box.

It is another object of the invention to provide a gift wrap roll storage and cutting box having a top lid that can be opened from the front by releasable fasteners.

It is a further object of the invention to provide a gift wrap roll storage and cutting box having a horizontal extracting slit in the rear of the lid and a cutting edge on the front edge of the lid.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front perspective view of a gift wrap roll storage and cutting box according to the present invention.

FIG. 2 is a rear perspective view of a gift wrap roll storage and cutting box according to the present invention.

FIG. 3 is a front perspective view of a gift wrap roll storage and cutting box with the lid open.

FIG. 4 is a front perspective view of an alternative embodiment of the gift wrap roll storage and cutting box with the lid open and having tab fastening members.

FIG. 5 is a section view drawn along lines 5-5 of FIG. 1.

Similar reference characters denote corresponding features consistently throughout the attached drawings.

### DETAILED DESCRIPTION OF THE PREFERRED EMBODIMENT

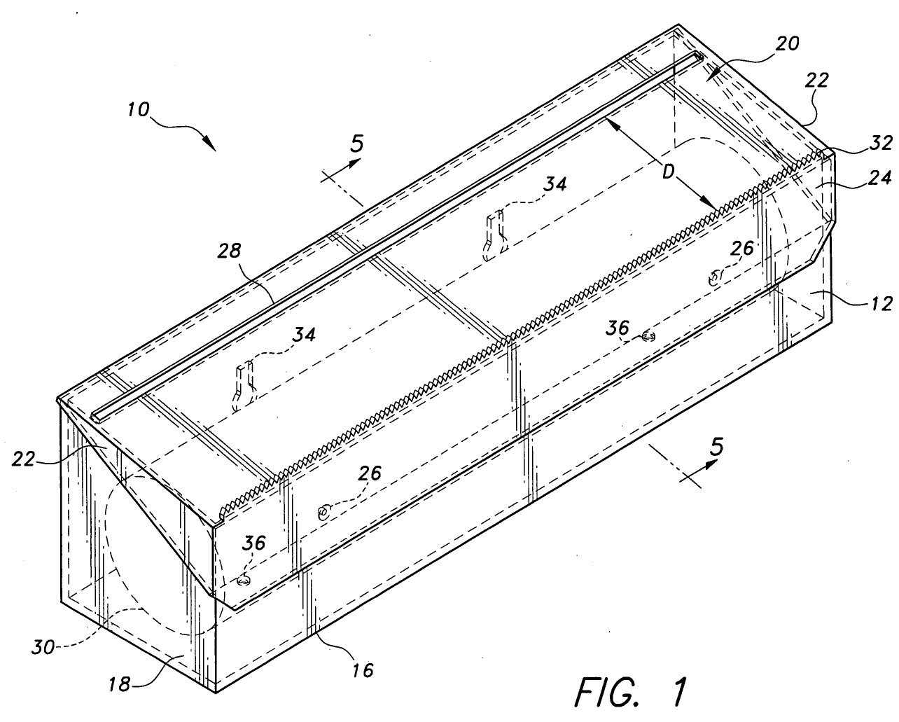

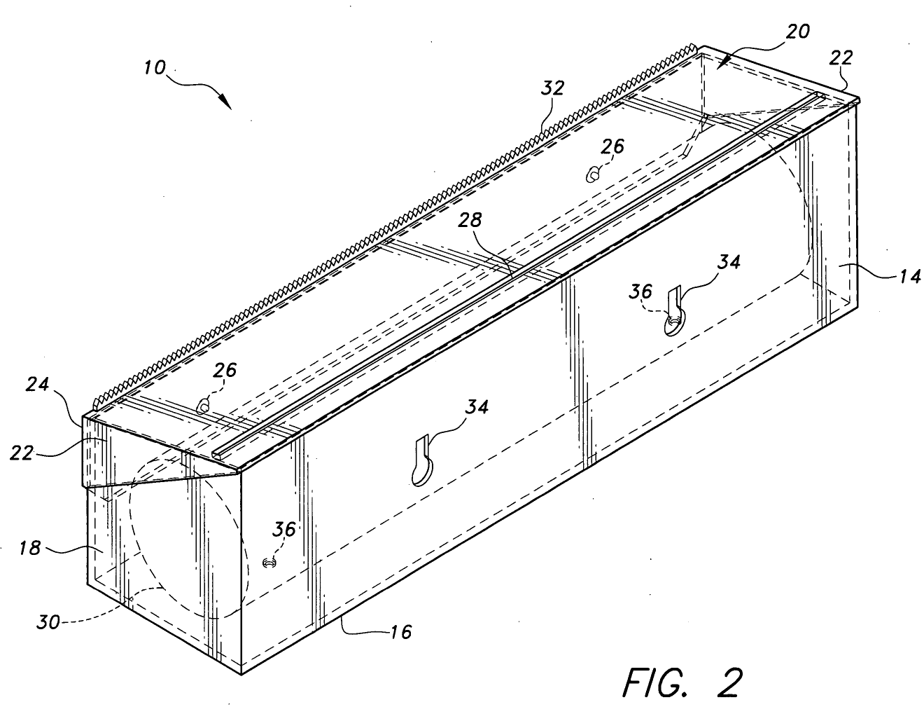

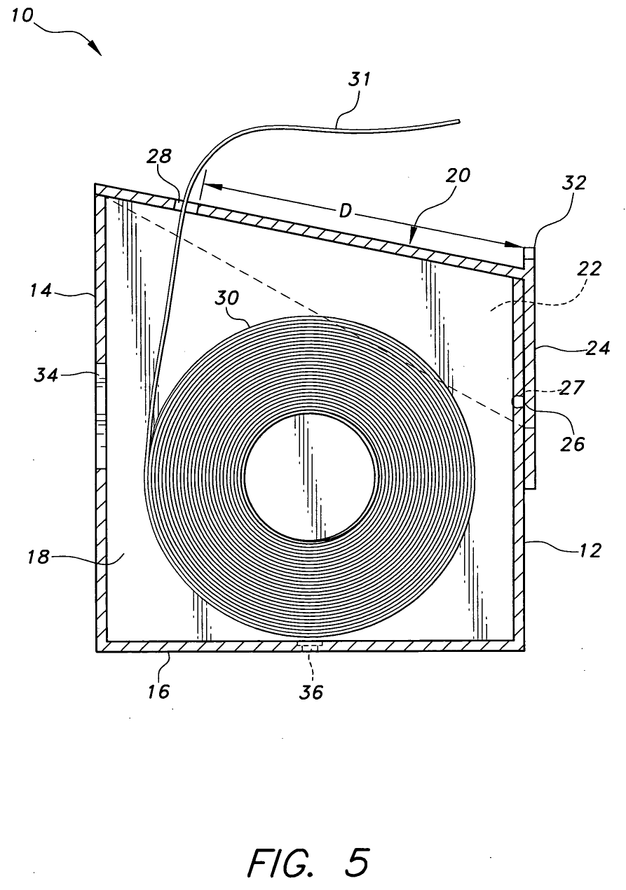

The present invention is a gift wrap roll storage and cutting box, designated as 10 in the drawings. As shown in FIGS. 1 and 2 in conjunction with FIG. 5, the box 10 is a rectangular container having a front wall 12, a rear wall 14, a bottom wall 16, and two end walls 18 that are connected to form an open-top cavity. The cavity retains and stores a roll of gift wrap paper 30. The rear wall 14 is taller than and parallel to the front wall 12; the two end walls 18 are parallel to each other.

A rectangular lid 20 conceals the cavity of the box 10. The lid 20 has a rear edge, a front edge, and two side edges with side lips 22 depending from the side edges and a central lip 24 depending from the front edge of the lid 20. The rear edge of lid 20 is pivotally joined to the rear wall 14 of the box 10. When the lid 20 is closed over the cavity, it lies down in an inclined slope from the tall rear wall 14 to the shorter front wall 12.

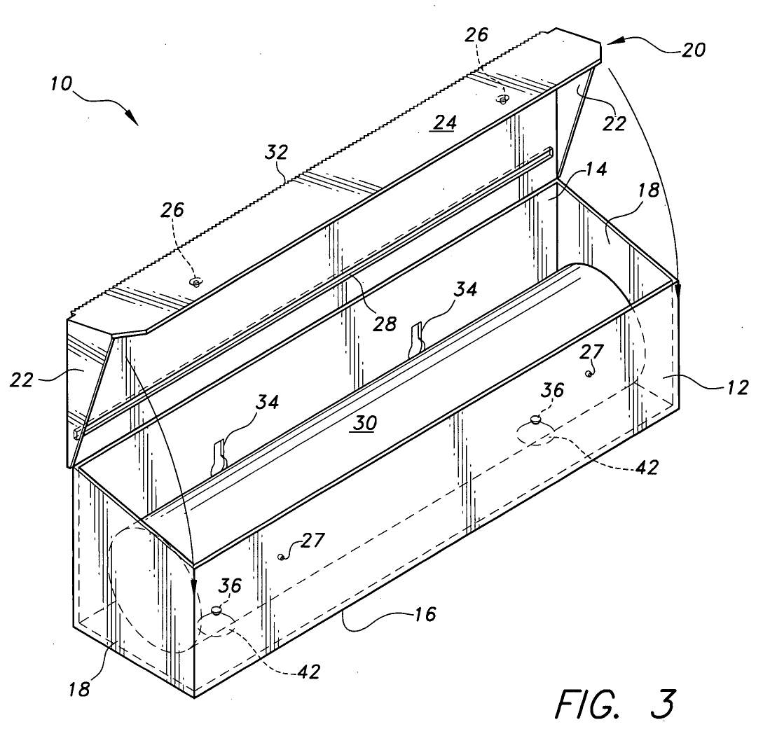

The lid 20 has a horizontal slit 28 defined therein, a serrated cutting edge 32, and fasteners 26 which mate with fasteners 27 (shown in FIG. 3) on front wall 12. The horizontal slit 28 is disposed adjacent to the rear wall 14 of said box 10. The slit 28 and is used to guide a single sheet 31 of gift wrap paper out and away from the roll 30 of gift wrap paper that is disposed within the cavity. The slit 28 is about a ¼″ wide, or any other width that is sufficient to allow a single sheet 31 or thickness of paper through the slit 28. The length of the slit 28 is generally the same length as the lid 20.

The serrated cutting edge 32 is disposed on the front edge of the lid 20 and is parallel to the horizontal slit 28. A distance D separates the slit 28 and the cutting edge 32. The distance D provides the user with a place to rest their hand and tear off a sheet of gift wrap paper. Once the desired length of paper is cut, the rest of the sheet 31 of gift wrap paper that is still attached to the roll 30 of gift wrap paper remains exposed on the lid 20 and is therefore easily accessible for future use.

The roll 30 of gift wrap paper is held securely within the cavity of the box 10 by lid 20. The lid 20 may be secured to the box 10 by fasteners 26 and 27. Fasteners 26 and 27 are shown in the drawings as mating snap fasteners, although any mating fasteners that keep the lid 20 securely closed on the box 10 as wrapping paper is drawn through the slit 28 can be used.

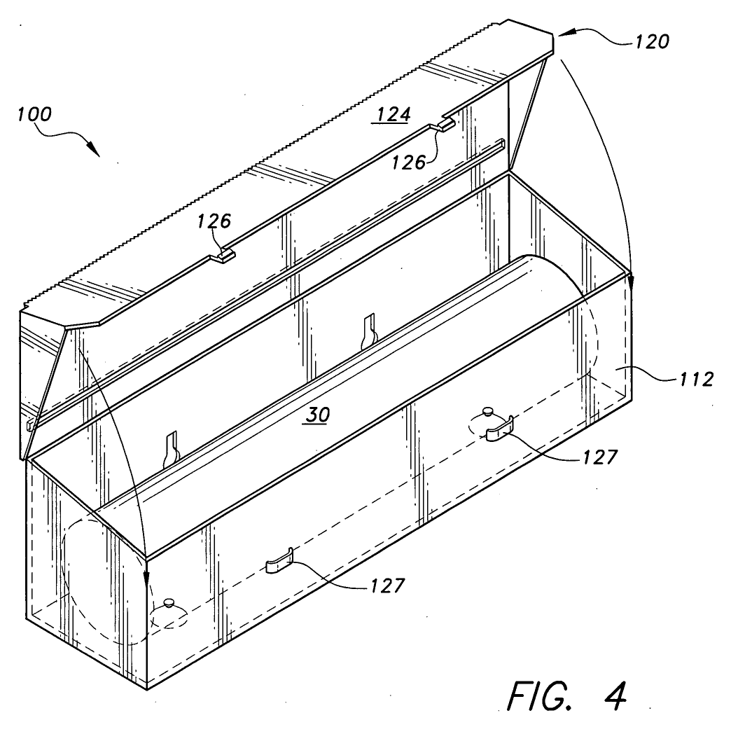

FIGS. 1-3 and 5 show the box 10 using snap closures fasteners 26 and 27. A first snap fastener 26 is disposed on the inside of the central lip 24 of the lid 20 and its corresponding fastener 27 is disposed on the front wall 12 of the box 10. Alternatively, as shown in FIG. 4, tab fasteners 126 and 127 may be used instead of snap fasteners 26 and 27. As shown in FIG. 4, box 100 has a first tab fastener member 126 disposed on an edge of the central lip 124 of the lid 120 and its corresponding securing loop 127 is disposed on the front wall 112.

The box 10 may be used as a handheld device or as a surface mounted device. As shown in FIGS. 3 and 4, the box 10 has knock out keyholes 34 disposed on the rear wall 14 and knock out keyholes 36 disposed on the bottom wall 16. The keyholes 34 are use to mount the box 10 on vertical surfaces, while keyholes 36 are use to mount the box 10 on horizontal surfaces. The drawings show the box 10 having a pair of keyholes 34 on the rear wall 14 and a pair of keyholes 36 on the bottom wall 16; the number of keyholes 34 and 36 may be more or less and should not be limited in number.

The keyholes 34 and 36 are used to accommodate attachment members, such as suction cups 42, nails, hooks, or other supports. Suction cups 42 may be placed within either keyholes 34 to hang the box 10 from a wall or keyholes 36 to keep the box 10 stationary on a table surface. Nails or hooks are best used with keyholes 34 located on the rear wall 14. The nails would have to be driven into a wall or door so that the box 10 would hang from keyholes 34.

The box 10 can be manufactured in different lengths, such as eighteen inches, thirty inches, and thirty-two inches. The width and height would be made to accommodate any size roll of gift wrap paper 30. The box 10 may be made of any material, such as cardboard, metal or plastic. The plastic box 10 can be injection molded from polyethylene, polypropylene, acrylic, and the like and may be transparent or opaque. Lid 20 may be pivotally attached to the rear wall 14 by a living hinge or the like.

It is to be understood that the present invention is not limited to the embodiment described above, but encompasses any and all embodiments within the scope of the following claims.

1. A gift wrap roll storage and cutting box, comprising:
a container having a front wall, a rear wall, a bottom wall, and two end walls connected together to form a box defining an open-top cavity, the rear wall being taller than the front wall, the cavity being dimensioned and configured for retaining and storing a roll of gift wrap paper;
a lid having a rear edge, a front edge, and two side edges, the rear edge being pivotally attached to the rear wall of the container, the lid sloping downward over the front wall and concealing the cavity when the lid is in a closed position, the lid having a horizontal slit defined therein adjacent and parallel to the rear wall of the container; and
a serrated cutting edge, the serrated cutting edge being disposed on the lid adjacent the front edge of the lid, the serrated cutting edge being parallel to the horizontal slit;
whereby a sheet of gift wrap paper is drawn away from the roll of gift wrap paper through the slit disposed on the lid and severed along the serrated cutting edge disposed on the front edge of the lid.

2. The box according to claim 1, further comprising two side lips depending from the side edges of said lid and a central lip depending from the front edge of said lid.

3. The box according to claim 1, further comprising mating fasteners disposed on said lid and the front wall of said container for securing said lid in the closed position.

4. The box according to claim 1, further comprising tab fasteners having a tab portion attached to said lid and a receiving loop portion attached to the front wall of said container for securing said lid in the closed position.

5. The box according to claim 1, further comprising mating snap fasteners including a first snap portion attached to said lid and a second corresponding snap portion attached to the front wall of said container for securing said lid in the closed position.

6. The box according to claim 1, further including knock out keyholes disposed on the rear wall of said container.

7. The box according to claim 1, further including knock out keyholes disposed on the bottom wall of said rectangular container.

8. The box according to claim 7, further comprising suction cups extending from the keyholes.

9. The box according to claim 1, wherein the container is made of plastic.

10. The box according to claim 9, wherein the plastic is transparent.

11. The box according to claim 9, wherein the plastic is translucent.

12. The box according to claim 12, wherein the plastic is opaque.

13. The box according to claim 1, wherein the container is made of cardboard.

14. The box according to claim 1, wherein the container is made of metal.
